(19) United States
(12) Patent Application Publication
(10) Pub. No.: US 2013/0340581 A1
(43) Pub. Date: Dec. 26, 2013

(54) BASEPLATE FOR A HANDHELD POWER TOOL

(71) Applicants: Stefano Delfini, Bettlach (CH); Heiner Storck, Korntal-Muenchingen (DE)

(72) Inventors: Stefano Delfini, Bettlach (CH); Heiner Storck, Korntal-Muenchingen (DE)

(73) Assignee: Robert Bosch GmbH, Stuttgart (DE)

(21) Appl. No.: 13/993,914

(22) PCT Filed: Nov. 23, 2011
(86) PCT No.: PCT/EP2011/070749

§ 371 Date: Sep. 9, 2013

(30) Foreign Application Priority Data
Dec. 14, 2010 (DE) 102010063079.9
Feb. 15, 2011 (DE) 102011004114.1

(51) Int. Cl. B25F 5/00; B26B 27/00; B23Q 9/00

(52) U.S. Cl. CPC B25F 5/00; B23Q 9/0007; B26B 27/00
USPC 83/13; 30/296.1; 30/371; 30/475; 409/182

(57) ABSTRACT

A baseplate for a handheld power tool has an underside configured to be guided along the surface of a workpiece when working the workpiece. The baseplate is configured to be made to vibrate by a vibration-inducing device.

The invention relates to a baseplate for a handheld power tool in accordance with the preamble of claim 1.

### PRIOR ART

Handheld power tools, such as jigsaws, have a baseplate or foot plate which rests on the workpiece upper side during machining and via which the handheld power tool is supported on the workpiece and is guided on the latter. In the case of a jigsaw, the baseplate or footplate has a recess, through which the saw blade protrudes for workpiece machining.

In handheld power tools of this type, there is generally the problem that the baseplate slides over the workpiece upper side with friction, it being necessary for the frictional force to be overcome during the advancing movement by the operating person who actuates the handheld power tool, which requires an increased exertion of force. Moreover, sudden changes in the coefficient of friction between the baseplate and the workpiece upper side can lead to changes in the advancing speed, which can lead to impairments in the sawing pattern.

### DISCLOSURE OF THE INVENTION

The invention is based on the object of improving the handling of a handheld power tool, which is provided with a baseplate, during the machining of a workpiece, by way of simple measures.

According to the invention, this object is achieved by way of the features of claim 1. The subclaims specify expedient developments.

The baseplate according to the invention is used in motor-operated handheld power tools, in particular in handheld power tools with an electric drive motor, such as jigsaws or hacksaws, circular hand saws, routers, planes or the like. The baseplate is fastened to the handheld power tool and is guided with the underside along the workpiece surface. It is provided according to the invention that the baseplate is assigned a vibration-inducing device which serves to generate vibrations in the baseplate and/or a component which is arranged on the baseplate. The vibrations are generated during the movement of the handheld power tool and are superimposed on said movement.

The baseplate or the component which is arranged on the baseplate is therefore subjected to two superimposed movements, namely firstly the movement which is exerted on the baseplate or foot plate via the handheld power tool, and secondly the vibration movement which is generated by the vibration-inducing device. These are periodic vibrations with a small vibration amplitude and a usually comparatively high vibration frequency, which vibrations are not sensed or are scarcely sensed by the operating person and subjectively blend into the background during the workpiece machining on account of the motor vibrations and jolts which occur in the process. The superimposed vibrations in the baseplate or the component which is arranged on the baseplate are small enough not to disrupt the advancing movement of the handheld power tool.

At the same time, the advancing force which is required for the advancing movement is reduced significantly. Movements transversely with respect to the advancing direction and rotational movements about the vertical axis of the baseplate can also be carried out with less exertion, as a result of which the handling of the handheld power tool is improved discernibly. In principle, on account of the inducing of vibrations, only the sliding friction between the baseplate or a component which is arranged on the baseplate and the workpiece surface has to be overcome, but not any static friction, as a result of which a more uniform movement of the handheld power tool is possible while avoiding jolt-like or non-constant movements.

For example, the start of the advancing movement is facilitated as a result. Moreover, the risk is reduced that sudden changes in the coefficient of friction lead to unexpected acceleration or braking of the advancing movement. As a result, more ergonomic machining with a reduced risk of fatigue and higher machining precision is possible.

The vibrations which are generated by the vibration-inducing device move in the plane of the baseplate according to one advantageous embodiment. In particular, vibration generation along the advancing direction comes into consideration, with the result that the superimposed vibrations lead to a movement component which is directed in the same direction as the advancing direction and a movement component which is directed in the opposite direction. However, in addition or as an alternative, vibration generation is also possible in principle in the plane of the baseplate, but transversely with respect to the advancing direction, and/or vertically with respect to the plane of the baseplate, that is to say in the direction of the vertical axis of the handheld power tool.

The baseplate per se and/or a component which is arranged on the baseplate are/is set vibrating via the vibration-inducing device. Said component is preferably a contact component which is arranged on the underside of the baseplate and is in contact with the workpiece surface during workpiece machining. The inducing of vibrations is possible either only in the contact component, only in the baseplate or both in the contact component and in the baseplate.

Furthermore, it is possible to arrange or fasten an additional baseplate on a conventionally configured baseplate in the manner of a supplementary module, which additional baseplate is assigned a vibration-inducing device. The additional baseplate with the vibration-inducing device is advantageously fastened to the underside of the existing baseplate and is in contact with the workpiece upper side during machining.

In the case of the inducing of vibrations only in the contact component, the vibration-inducing device is expediently situated directly on the contact component, wherein it is expedient to provide vibration decoupling measures between the contact component and the baseplate, for example decoupling elements, damping elements or guide elements which make a relative movement between the contact component and the baseplate possible in the plane of the vibrations during the induced vibrations. In the case of an excitation of the baseplate, the vibration-inducing device can be situated both on the upper side and on the underside or in the side region or in a recess in the baseplate. It is possible, for example, to connect a mass component to the baseplate, which mass component is set vibrating and transmits said vibrations to the baseplate on account of its inherent mass.

Various action principles can be realized as vibration-inducing device. According to one preferred embodiment, the inducing of vibrations by means of one or more piezoelectric elements comes into consideration, which piezoelectric elements experience a change in length when an electric voltage is applied. In the case of vibrations being induced in a contact component on the underside of the baseplate, a piezoelectric element is arranged directly on the contact component, which piezoelectric element can be loaded with a control voltage, in order to induce the desired vibrations in the contact component. It is possible, for example, to connect two immediately adjacent contact components by way of in each case one piezoelectric element and to set the latter vibrating. Each contact component expediently has at least one contact surface which rests on the surface of the workpiece during workpiece machining. For stable guidance of the handheld power tool of the baseplate, it can be expedient to provide in each case one or more contact components or vibration-inducing devices in each corner region of the baseplate. However, embodiments with a reduced number of vibration-inducing devices are also possible, for example only one vibration-inducing device which can be arranged symmetrically with respect to a longitudinal axis of the baseplate.

A piezoelectric element can also be used in the case of vibrations being induced in the baseplate itself. By way of example, the mass component is thus connected to the baseplate via one or more piezoelectric elements, wherein the mass component is set vibrating by way of the application of the control voltage, which vibrations are transmitted to the baseplate.

The vibration-inducing device can act on the contact component or directly on the baseplate. In the last-mentioned case, the vibration-inducing device is inserted, for example, into a recess in the baseplate or is connected to the surface of the baseplate, for example is adhesively bonded onto the baseplate.

Both resonant and non-resonant vibrations can be induced via the vibration-inducing device.

It is provided in a further expedient embodiment that at least one roller is arranged on the underside of the baseplate, which roller is present in addition to the vibration-inducing device. The roller advantageously lies at a distance from the vibration-inducing device. Optionally, two rollers are arranged on the baseplate, which rollers lie, in particular, parallel to one another.

Further advantages and expedient embodiments can be gathered from the further claims, the description of the figures and the drawings, in which:

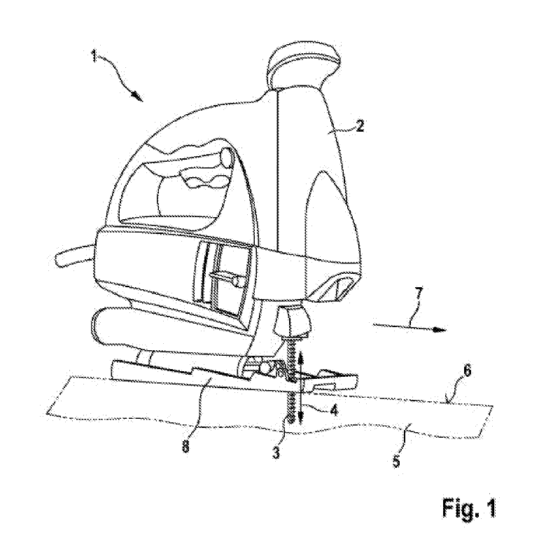

FIG. 1 shows a perspective illustration of a hand-held jigsaw which has a baseplate or foot plate which is guided on the surface of the workpiece during workpiece machining,

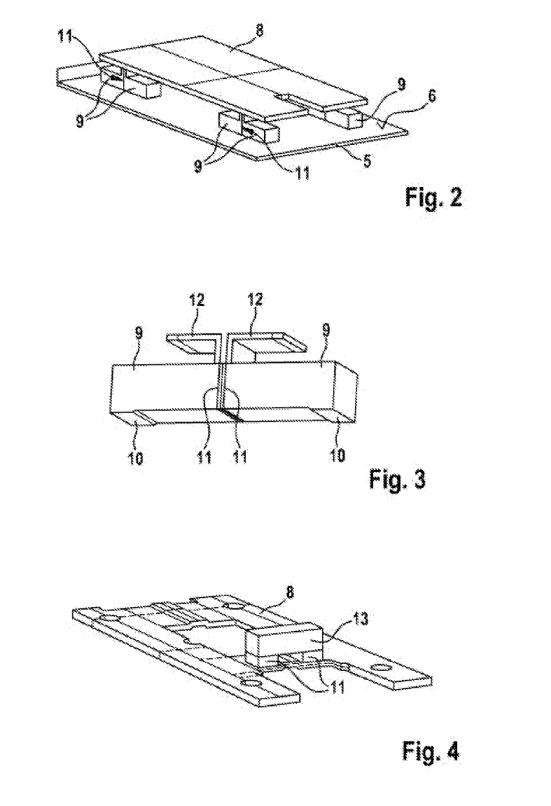

FIG. 2 shows a diagrammatic illustration of a foot plate with contact components which are arranged on the underside and can be set vibrating via piezoelectric elements,

FIG. 3 shows two contiguous contact components with piezoelectric elements which lie between them,

FIG. 4 shows a further embodiment of a baseplate with a vibration-inducing device, via which the baseplate itself can be set vibrating,

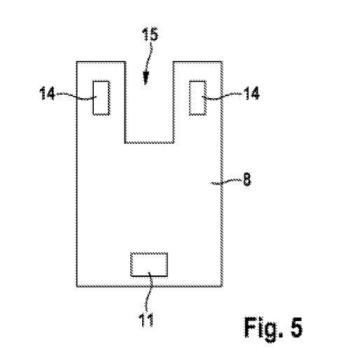

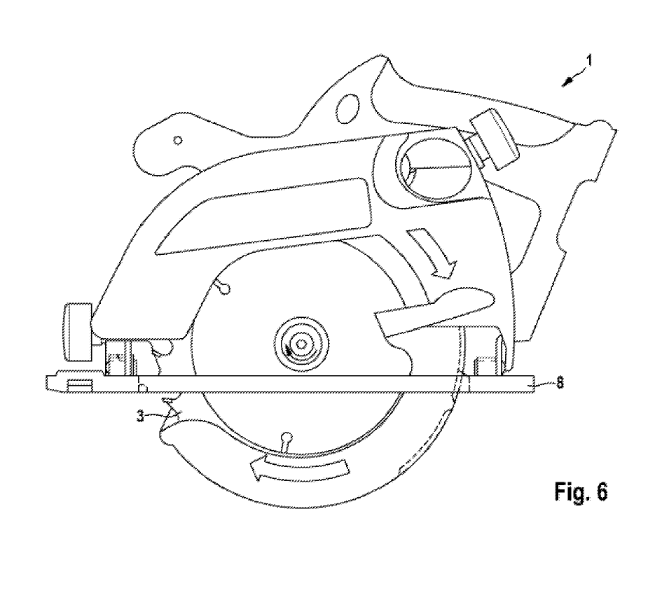

FIG. 5 shows another embodiment of a baseplate,

FIG. 6 shows a circular handsaw as a further exemplary embodiment,

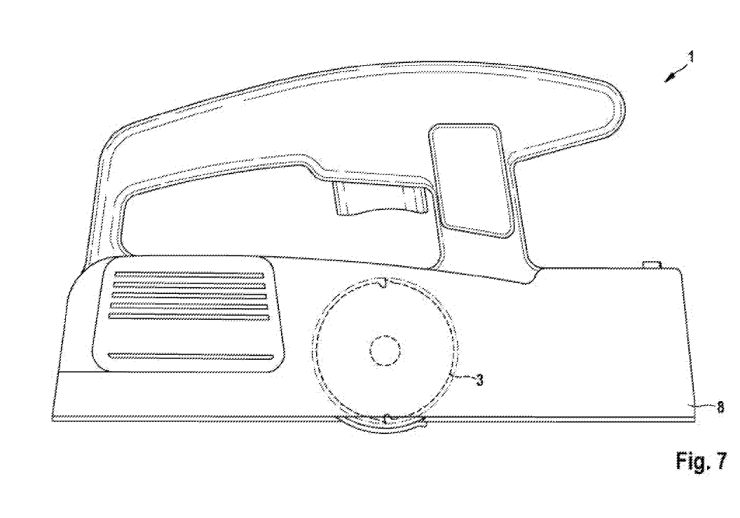

FIG. 7 shows a hand plane as a further exemplary embodiment, and

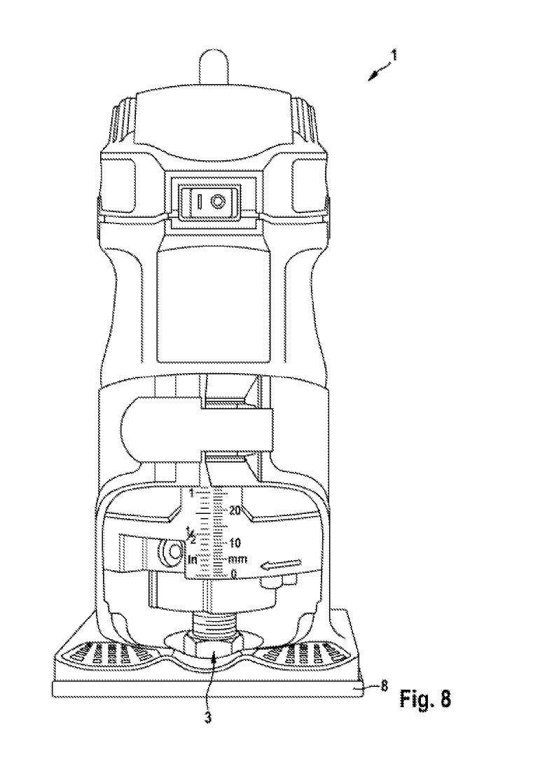

FIG. 8 shows a router as a further exemplary embodiment.

In the figures, identical components are provided with identical designations.

FIG. 1 shows a hand-held jigsaw 1 as handheld power tool, which jigsaw 1 has a motor-driven saw blade 3 in a housing 2, which saw blade 3 performs a reciprocating movement according to arrow 4 during workpiece machining. The jigsaw 1 has a baseplate 8 which is connected to the handheld power tool and which rests on the surface 6 of the workpiece 5 during workpiece machining and slides along in the advancing direction 7. The saw blade 3 is guided through a recess in the baseplate 8.

In order to improve the handling capability and to reduce the forces which are required for the movement of the baseplate on the workpiece surface during workpiece machining, so that an improved work result can also be achieved, it is provided to set the baseplate 8 vibrating, which vibrations are superimposed on the advancing movement 7. The vibrations preferably lie in the plane of the baseplate 8 in the direction of the advancing movement 7. Said vibrations are superimposed on the advancing movement, wherein the vibrations have a small amplitude and a high frequency, with the result that the advancing movement is not impaired by the vibrations. The vibrations are either generated directly in the baseplate 8 or in contact components which are situated on the underside of the baseplate 8 and which rest on the surface 6 of the workpiece 5 during workpiece machining.

FIGS. 2 and 3 show one exemplary embodiment for generating vibrations in contact components 9 on the underside of the baseplate 8. In each corner region of the baseplate 8, in each case two directly linked contact components 9 are situated which have in each case one outer contact surface 10 on the underside, as can be gathered from FIG. 3, with which contact surface 10 the contact components 9 rest on the surface 6 of the workpiece 5. The contact surfaces 10 can extend only over a part area of the underside of the contact components and can be composed of a low-friction material. In the exemplary embodiment, the two contact surfaces 10 are arranged adjacently with respect to opposite end sides of the two contact components 9.

Piezoelectric elements 11 which are arranged directly on an end side of each contact component 9 serve as vibration-inducing device. When a control voltage is applied, the extent of the piezoelectric elements 11 changes, wherein a high-frequency vibration can be generated in the piezoelectric element 11 via a corresponding frequency of the control voltage, which high-frequency vibration is transmitted to the respective contact component 9 on account of the direct contact. Each pair of contact components which is positioned in each corner region on the underside of the baseplate 8 is assigned two piezoelectric elements on the mutually facing end sides of the linked contact components 9. The pairs of contact components are advantageously braced, which can be achieved, for example, by virtue of the fact that the two contact components 9 are screwed to one another. Thus, for example, a recess can be made in the piezoelectric elements, through which recess a screw is guided, via which the two contact components 9 are screwed fixedly to one another.

Furthermore, each contact component 9 is assigned a connecting element 12, via which the contact component 9 is connected to the underside of the baseplate 8. The connecting element 12 is configured as an angle flange. However, it is also possible to provide only a single connecting element 12 for two linked contact components 9.

FIG. 4 shows a further exemplary embodiment, in which the baseplate 8 is set vibrating directly via a vibration-inducing device.

Vibration decoupling between the contact components 9 and the baseplate 8 can optionally also take place via the connecting elements 12, for example by way of a soft design of the connecting elements 12 or a damping element which lies in between and is arranged between the connecting elements 12 and the underside of the baseplate 8.

The vibration-inducing device comprises a seismic mass component 13 on the upper side of the baseplate 8 and two piezoelectric elements 11, via which the mass component 13 is connected to the baseplate 8. When the piezoelectric elements 11 are excited, the mass component 13 is set vibrating, which vibrations are transmitted at the same time to the baseplate 8, with the result that the baseplate 8 performs a vibration which is superimposed on the advancing movement, as a result of which the advancing forces are reduced.

FIG. 5 shows a further exemplary embodiment of a baseplate 8 for a handheld power tool, wherein the baseplate 8 is to be set vibrating via a vibration-inducing device 11. Rollers 14 which are intended to facilitate the advancing movement are situated on the underside of the baseplate 8 which rests on the workpiece surface during machining. Two axially parallel rollers 14 are provided which are situated on in each case one arm of the baseplate, wherein a recess 15 is formed in the baseplate between the arms, through which recess 15 the tool of the handheld power tool protrudes.

Furthermore, a vibration-inducing device 11 is arranged on the baseplate 8, for example in the form of a piezoelectric element, in order for it to be possible to set the baseplate vibrating, which vibrations are superimposed on the advancing movement of the baseplate. In the exemplary embodiment, only a single vibration-inducing device 11 is provided which is arranged symmetrically with respect to a longitudinal axis or longitudinal center plane of the baseplate 8. The vibration-inducing device 11 is situated at a spacing from the two rollers 14, wherein the rollers 14 and the vibration-inducing device 11 are arranged on the baseplate 8 such that they lie diametrically opposite one another.

FIGS. 6 to 8 show further exemplary embodiments with in each case one handheld power tool 1 which is provided in each case with a baseplate 8, through which the tool 3 protrudes for machining the workpiece which lies underneath. The exemplary embodiment according to fig. is concerned with a circular hand saw, FIG. 7 is concerned with a hand plane with two baseplates, and FIG. 8 is concerned with a router. The baseplate 8 or the baseplates of each handheld power tool 1 is/are to be set vibrating, as described above, by means of a vibration-inducing device, in order to facilitate or to improve the guidance over the workpiece upper side.

1. A baseplate for a handheld power tool, comprising:
a baseplate body fastened on the handheld power tool, the baseplate body having an underside configured to be guided along a surface of a workpiece during workpiece machining; and
a vibration-inducing device configured to generate vibrations in one or more of the baseplate body and a component arranged on the baseplate body.

2. The baseplate as claimed in claim 1, wherein the vibrations are configured to be generated in the plane of the baseplate body via the vibration-inducing device.

3. The baseplate as claimed in claim 2, wherein the vibrations are configured to be generated in an advancing direction of the handheld power tool.

4. The baseplate as claimed in claim 2, wherein the vibrations are configured to be generated transversely with respect to an advancing direction of the handheld power tool.

5. The baseplate as claimed in claim 1, wherein the baseplate body itself is to be set vibrating via the vibration-inducing device.

6. The baseplate as claimed in claim 1, further comprising at least one contact component arranged on the underside of the baseplate body, the contact component being configured to be set vibrating via the vibration-inducing device.

7. The baseplate as claimed in claim 1, wherein the vibration-inducing device comprises at least one piezoelectric element.

8. The baseplate as claimed in claim 7, wherein the vibration-inducing device comprises two adjacent piezoelectric elements.

9. The baseplate as claimed in claim 7, wherein the piezoelectric element is arranged on a contact component on the underside of the baseplate body.

10. The baseplate as claimed in claim 7, wherein the piezoelectric element is arranged on a mass component connected to the baseplate body.

11. The baseplate as claimed in claim 1, further comprising at least one roller is arranged on the underside of the baseplate body.

12. The baseplate as claimed in claim 11, wherein the vibration-inducing device is arranged on the baseplate body at a spacing from the roller.

13. A handheld power tool, comprising:
a baseplate including:
a baseplate body fastened on the handheld power tool, the baseplate body having an underside configured to be guided along a surface of a workpiece during workpiece machining; and
a vibration-inducing device configured to generate vibrations in one or more of the baseplate body and a component arranged on the baseplate body.

14. A method for operating a handheld power tool having a baseplate, the baseplate including a baseplate body fastened on the handheld power tool, the baseplate body having an underside configured to be guided along a surface of a workpiece during workpiece machining, the method comprising:
vibrating one or more of the baseplate body and a component arranged on the baseplate body with a vibration-inducing device configured to generate vibrations during the workpiece machining.

15. The method as claimed in claim 14, wherein the baseplate body or the component arranged on the baseplate body is set vibrating in one or more of a longitudinal, transverse, and vertical manner in relation to a plane of the baseplate body.

16. The handheld power tool as claimed in claim 13, wherein the handheld power tool is a jigsaw, a hacksaw, a circular hand saw, a router, or a plane.
